(19) United States
(12) Patent Application Publication
(10) Pub. No.: US 2024/0157830 A1
(43) Pub. Date: May 16, 2024

(54) ELECTRIC VEHICLE CHARGING ROADWAY POWERED BY STANDALONE DYNAMIC OUTPUT HYDROGEN FUEL CELLS

(71) Applicants: Gurjeet Gulati, New City, NY (US); Barry Hartsfield, Beverly Hills, CA (US)

(72) Inventors: Gurjeet Gulati, New City, NY (US); Barry Hartsfield, Beverly Hills, CA (US)

(21) Appl. No.: 18/508,065

(22) Filed: Nov. 13, 2023

Related U.S. Application Data
(60) Provisional application No. 63/383,425, filed on Nov. 11, 2022.

(51) Int. Cl. B60L 53/39; B60L 53/54; B60L 53/57; H01M 8/04858; H02J 50/10; H02J 50/40

(52) U.S. Cl. CPC B60L 53/39; B60L 53/54; B60L 53/57; H01M 8/04932; H02J 50/10; H02J 50/40; H01M 2250/10

(57) ABSTRACT

The present invention is a system and method for providing electrical power to a charging roadway, wherein the charging roadway provides inductive charging of an electrically powered vehicle, and wherein the charging roadway receives electrical power from one or more standalone hydrogen fuel cells, wherein the hydrogen fuel cells can operate in remote locations, and wherein the standalone hydrogen fuel cells can operate day or night, in good weather or bad, in cloud cover, and in calm or windy conditions, and without the use of battery backup.

### BACKGROUND

Field of the Invention: This invention relates generally to power systems that enable wireless charging of electric vehicles. More specifically, the road segments that provide wireless charging may be far from connections to an electric grid, and therefore require an alternate means of power. The powered road segments obtain electricity from standalone hydrogen fuel cells that have dynamic output that may adjust electric output according to power demands.

Description of Related Art: Alternative fuel vehicles are becoming ubiquitous on roadways, but efforts to fuel them are difficult because of a lack of charging infrastructure. Electric and hybrid vehicles that include a gas engine and electric motors are also gaining popularity. However, charging these vehicles remains difficult as the infrastructure to provide electrical charging stations is slow to be built.

Inductive charging systems have been developed in which no cord is needed between a charging system and the electric vehicle. Instead, wireless charging systems may be embedded in or just under the surface of the road, thereby enabling a vehicle traveling on the road to be charged either while it is stopped or while it is traveling on the roadway. However, providing electrical power to the charging road segments is taught in the prior art as requiring direct access to an electrical power grid. This requirement eliminates many desirable locations that could be used for charging a vehicle while the vehicle is moving.

It is useful to look at one particular example of a prior art roadway in order to understand the benefits of the present invention. For example, in FIG. 1, a roadway 10 is shown that included multiple lanes 12, and a subset of the multiple lanes was one or more charging lanes 14. The road segments may include road attributes including a lane charging attribute 16 that indicated whether a particular lane is a charging lane.

The roadway 10 included one or more indicators 16 that indicated that a charging lane was a charging lane. One or more of the indicators 16 was a permanent indicator, such as paint or reflectors on the roadway surface 18. A charging controller 20 and charging devices 22 embedded in or on the roadway 10 may control and/or power the temporary indicators 16.

Alternatively, the temporary indicator 16 could also be controlled by the charging controller 20. The charging devices 22 could be placed along the roadway 10 at specific intervals. Faster roadways may include charging devices 22 at smaller intervals. For example, charging devices 22 on arterial roads may have a first interval (e.g., small intervals), charging devices 22 on collector roads may have a second interval (e.g., medium intervals), and/or charging devices 22 on local roads may have a third interval (e.g., large intervals). The interval for charging devices 22 may be inversely proportional to the speed of the road because charging can be accomplished using fewer charging devices in the road because vehicles are traveling slower and spend more time adjacent to the charging devices.

The charging devices 22 may also be energized at different intervals such that certain charging devices 22 are on and certain charging devices are off at any given time. For example, the charging controller 20 could establish multiple modes of coverage for the charging devices 22. A high mode of coverage may include activation of all of the charging devices 22, which maximizes the electrical charge received by the vehicles. A medium mode of coverage may include activation of less than all of the charging devices 22 (e.g., every other charging device, every third charging device, every fourth charging device, or another percentage of the charging devices), which provides a medium level of electrical charge received by the vehicles. A low mode of coverage may include activation of a lower number of the charging devices 22 (e.g., every third charging device, every fourth charging device, or another percentage of the charging devices), which provides a lower level of electrical charge received by the vehicles.

An important aspect all embodiments of the prior art is the power source for the charging devices 22 used in the charging lane 14. FIG. 1 shows that the power source 24 is an electrical power grid.

Similarly, FIG. 2 shows that the power source is an alternative power source such as solar and/or wind power.

Unfortunately, all of the power sources 24 shown in the prior art either require a direct connection to an electrical power grid or use a connection to an unreliable power source.

For example, solar power only works during daylight hours and may not work on stormy days or days with significant cloud cover. Likewise, wind power only works if there is sufficient wind to generate electricity and therefore does not operate when the winds are calm.

Furthermore, the solar and wind power options may simply not be available near the charging lanes 14 of the roadway 10. While backup batteries might be provided, batteries would substantially increase the cost of the power source.

Accordingly, it would be an advantage over the prior art to provide alternate means of providing power to charging roadways when access to an electrical power grid is not possible or it is impractical. It would be another advantage if the power was available during the day and night, in calm weather and stormy weather, and regardless of cloud cover. It would be another advantage if the power source did not require a significant amount of space and if it did not require a costly backup power supply such as batteries.

### BRIEF SUMMARY

The present invention is a system and method for providing electrical power to a charging roadway, wherein the charging roadway provides inductive charging of an electrically powered vehicle, and wherein the charging roadway receives electrical power from one or more standalone hydrogen fuel cells, wherein the hydrogen fuel cells can operate in remote locations, and wherein the standalone hydrogen fuel cells can operate day or night, in good weather or bad, in cloud cover, and in calm or windy conditions, and without the use of battery backup.

In a first aspect of the invention, the standalone hydrogen fuel cells are disposed adjacent to the charging roadways.

In a second aspect of the invention, no battery backup is required as the hydrogen fuel cell is able to generate electricity on demand and at any time of day or night.

In a third aspect of the invention, the standalone hydrogen fuel cells may be refilled as needed with a fuel in order to keep the charging roadways functioning.

In a fourth aspect of the invention, the standalone hydrogen fuel cells may provide power on demand and thus provide less power when less power is needed but then ramp up and provide more power in high power demand situations.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a top view of a roadway that includes a charging lane as taught in the prior art, wherein the power source is an electrical power grid.

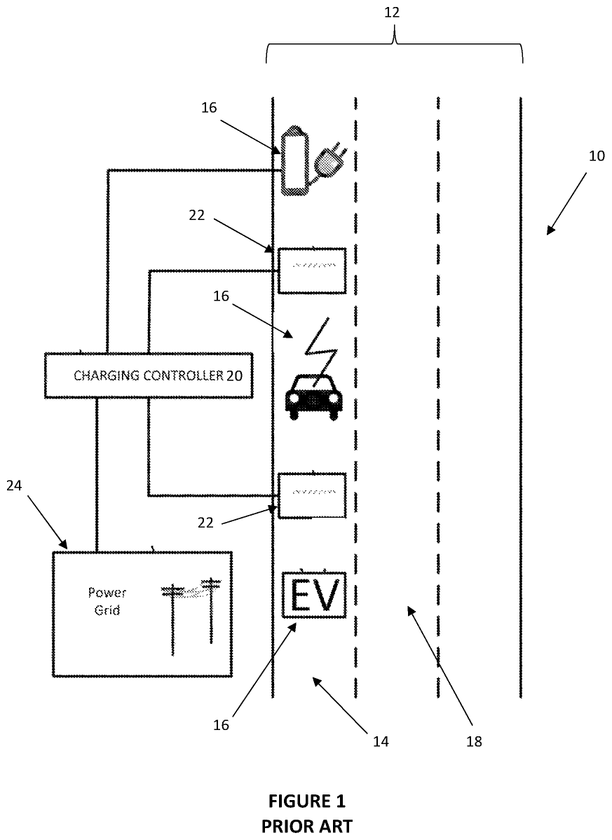

FIG. 2 is a top view of a roadway that includes a charging lane as taught in the prior art, wherein the power source is solar or wind power.

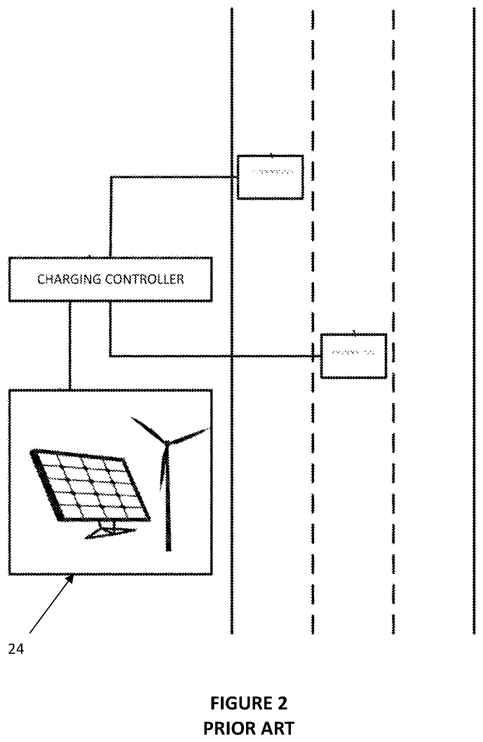

FIG. 3 is a top view of a roadway that includes a charging lane as taught in the prior art, wherein the power source is at least one hydrogen fuel cell.

FIG. 4 is top view of an alternate embodiment of the present invention where the charging lanes 14 are now separated from the roadway.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

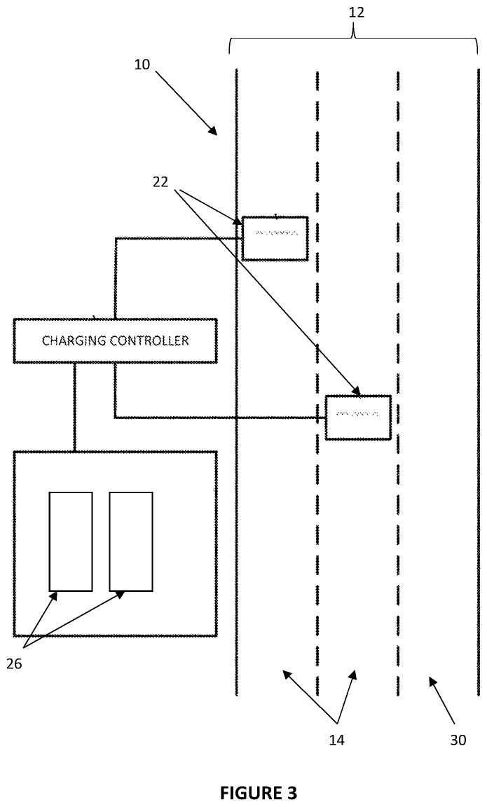

FIG. 3 is a top view of a first embodiment of the invention, wherein a charging roadway 10 is comprised of a plurality of lanes 12 that are both charging lanes 14 and non-charging lanes 30. The power source in the first embodiment of the invention may be one or more hydrogen fuel cells 26. The fuel cells may be disposed close to the roadway 10 and provide quick access for refueling. The fuel cells 26 may also be highly efficient and self-contained hydrogen fueled systems. The fuel cells 26 may also be capable of dynamically providing power on demand and therefore capable of conserving fuel when less power is needed and providing more energy when power demands increase.

Fuel cells may advantageously operate like batteries in that they are self-contained power sources, but they do not run down or need recharging. As long as they can be refueled, they can continue to provide the desired power. They may produce both electricity and heat as long as the fuel is supplied.

A hydrogen fuel cell consists of two electrodes, a negative electrode (or anode) and a positive electrode (or cathode) that is disposed around an electrolyte. A fuel, such as hydrogen, is fed to the anode, and air is fed to the cathode. In a hydrogen fuel cell, a catalyst at the anode separates hydrogen molecules into protons and electrons, which take different paths to the cathode. The electrons go through an external circuit, creating a flow of electricity that may be used to power the charging lanes 14 as shown in FIG. 3. The protons migrate through the electrolyte to the cathode, where they unite with oxygen and the electrons to produce water and heat.

In the case that hydrogen may be difficult to store at the location of the charging lanes 14, other fuels that are easier to store may also be used to power a fuel cell. For example, natural gas is easier to store and is plentiful and may also function as a fuel source.

Natural gas is primarily composed of methane (CH4), so the hydrogen needs to be separated from the carbon to be used in the fuel cell. This separation typically takes place in a device called a steam methane reformer that subjects the natural gas to steam at high temperature and pressure in the presence of a metal catalyst, usually nickel, that facilitates a chemical reaction which produces hydrogen, and small amounts of carbon dioxide and carbon monoxide. The resultant hydrogen is then fed to the fuel cell and the other gases are vented. Water output from the fuel cell can be captured and routed to the reformer, thereby recycling it to be heated into steam for the methane reformation process.

Fuel cells are energy-efficient since they produce electricity chemically rather than through combustion. Depending on the type of fuel cell, efficiency ranges from a low of 40 percent to a high of 80 percent and the electrical output ranges from 200 watts to several megawatts providing scalable options to meet the needs of even the most demanding charging roadway.

The fuel cells 26 of the present invention may be on-demand fuel cells that provide the desired amount of power by being a variable power source. Such a hydrogen fuel cell is taught in pending provisional patent application 63/383,657 and is incorporated herein by reference. The on-demand fuel cells 26 of the present invention may be capable of extending time between refueling by only providing as much power as is needed. Fuel cells are generally operated in stacks that when placed in series, are capable of increasing power output. However, changing the power output of a single fuel cell is generally more difficult to do. However, using the fuel cell technology of the above-referenced patent application, a single fuel cell is capable of variable power output on a large scale.

In addition, any fuel source that will work with a fuel cell should be considered to be within the scope of the invention. These fuel sources include all hydrogen-rich fuels such as methanol, ethanol, and hydrocarbon fuels that may be reformed to produce hydrogen.

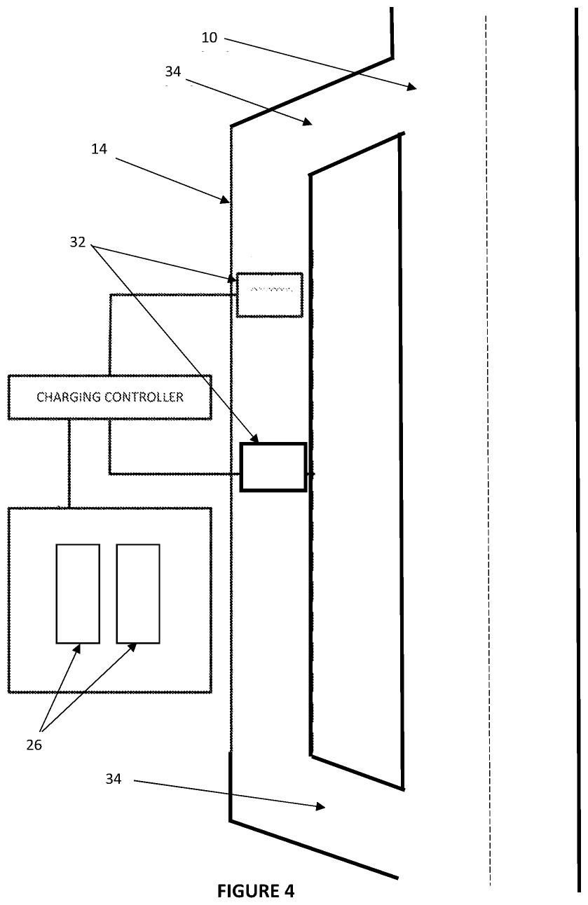

FIG. 4 is a top view of an alternate embodiment of the present invention. In this embodiment, the charging lane 14 is now separated from the non-charging roadway 10 and may be a separate roadway that is accessed by an on and off ramp 34. The charging lane 14 may be adjacent and parallel to the roadway 10 and enable charging vehicles to be out of regular non-charging traffic.

One advantage of this embodiment is that the vehicles using it for charging may travel at a speed that is optimized for charging, which may not be the speed of the roadway 10. Furthermore, the charging lane 14 may also include charging spots 32 where the vehicles pull off the main roadway 10 and come to a stop over a charging spot 32. Thus, this embodiment includes a charging lane 14 and charging spots 32 giving the driver the option of stopping or traveling but at a slower rate than the regular roadway 10.

In summary, the embodiments of the invention include a system for providing a fuel cell-based variable power system for providing electrical power to a charging roadway for electric vehicles, wherein the system may operate independent of a conventional power grid, said system comprised of the fuel cell for generating electricity, wherein the fuel cell can generate a variable amount of electrical power upon demand, a plurality of charging devices that receive the electrical power from the fuel cell, a charging controller that communicates with the fuel cell and determines how much electrical power should be delivered to the plurality of charging devices, and then directs the fuel cell to generate the electrical power, and a charging roadway that includes at least one charging lane that charges electric vehicles, wherein the plurality of charging devices are disposed in the at least one charging lane of the charging roadway and thereby charge the electrical vehicles.

A summary of the method of the invention includes a method for providing electrical power to a charging roadway for electric vehicles and operating independent of a conventional power grid, said method comprising providing a fuel cell for generating electricity, wherein the fuel cell can generate a variable amount of electrical power upon demand, providing a plurality of charging devices that receive the electrical power from the fuel cell, providing a charging controller that communicates with the fuel cell and determines how much electrical power should be delivered to the plurality of charging devices, and then directs the fuel cell to generate the electrical power, providing a charging roadway that includes at least one charging lane, disposing the plurality of charging devices in the at least one charging lane, determining how much electricity to generate from the fuel cell to thereby provide sufficient electric energy to the plurality of charging devices, and adjusting an electrical output of the fuel cell to provide electricity to power the plurality of charging devices in the at least one charging lane.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system for providing a fuel cell-based variable power system for providing electrical power to a charging roadway for electric vehicles, and wherein the system may operate independent of a conventional power grid, said system comprised of:
the fuel cell for generating electricity, wherein the fuel cell can generate a variable amount of electrical power upon demand;
a plurality of charging devices that receive the electrical power from the fuel cell;
a charging controller that communicates with the fuel cell and determines how much electrical power should be delivered to the plurality of charging devices, and then directs the fuel cell to generate the electrical power; and
a charging roadway that includes at least one charging lane that charges electric vehicles, wherein the plurality of charging devices is disposed in the at least one charging lane of the charging roadway and thereby charge the electrical vehicles.

2. The system as defined in claim 1 wherein the system further comprises selecting a hydrogen-rich fuel for the fuel cell from the group of fuels comprised of methanol, ethanol, and hydrocarbon fuels that may be reformed to produce hydrogen.

3. The system as defined in claim 2 wherein the plurality of charging devices are comprised of wireless charging devices.

4. The system as defined in claim 3 wherein the wireless charging devices are inductive charging devices.

5. The system as defined in claim 1 wherein the plurality of charging devices are spaced apart at different intervals so as to provide charging at selectable rates for a given rate of speed of the electric vehicle.

6. The system as defined in claim 1 wherein the charging roadway has at least one charging lane and at least one non-charging lane.

7. The system as defined in claim 1 wherein the charging roadway is separated from a non-charging roadway and accessed via an on and off ramp.

8. The system as defined in claim 7 wherein the charging roadway includes at least one charging lane and a plurality of charging spots for the electric vehicle to stop and charge.

9. The system as defined in claim 1 wherein the system is comprised of a plurality of fuel cells for generating electric energy.

10. A method for providing electrical power to a charging roadway for electric vehicles and operating independent of a conventional power grid, said method comprising:
providing a fuel cell for generating electricity, wherein the fuel cell can generate a variable amount of electrical power upon demand, providing a plurality of charging devices that receive the electrical power from the fuel cell, providing a charging controller that communicates with the fuel cell and determines how much electrical power should be delivered to the plurality of charging devices, and then directs the fuel cell to generate the electrical power;
providing a charging roadway that includes at least one charging lane;
disposing the plurality of charging devices in the at least one charging lane;
determining how much electricity to generate from the fuel cell to thereby provide sufficient electric energy to the plurality of charging devices; and
adjusting an electrical output of the fuel cell to provide electricity to power the plurality of charging devices in the at least one charging lane.

11. The method as defined in claim 10 wherein the method of determining how much electricity to generate from the fuel cell further comprises determining an electric load on the plurality of charging devices.

12. The method as defined in claim 10 wherein the method further comprises selecting a hydrogen-rich fuel for the fuel cell from the group of fuels comprised of methanol, ethanol, and hydrocarbon fuels that may be reformed to produce hydrogen.

13. The method as defined in claim 10 wherein the method further comprises changing a charging rate of an electrical vehicle by spacing apart the plurality of charging devices at different intervals so as to provide charging at selectable rates for a given rate of speed of the electric vehicle.

14. The method as defined in claim 10 wherein the method of changing a charging rate of an electrical vehicle further comprises:
disposing the plurality of charging devices in the at least one charging lane at relatively close intervals; and
providing electric energy to select ones of the plurality of charging devices based upon a speed of the electric vehicle and a rate at which electric charging is desired.

15. The method as defined in claim 10 wherein the method of providing a charging roadway that includes at least one charging lane further comprises:
providing a charging roadway that includes at least one non-charging lane;
separating the at least one charging lane from the at least one non-charging lane; and
providing an on and off ramp to the least one charging lane from the at least one non-charging lane.

16. The method as defined in claim 15 wherein the method further comprises providing a plurality of charging spots at which the electric vehicle may stop to charge.

17. The method as defined in claim 10 wherein the method further comprises increasing a total amount of electric energy that may be provided to the plurality of charging device by adding one or more fuel cells.

18. The method as defined in claim 10 wherein the method further comprises providing wireless charging for the electric vehicle by using inductive charging devices as the plurality of charging devices.

19. The method as defined in claim 10 wherein the method further comprises periodically refueling the fuel cell so that the fuel cell is always ready to provide variable electric energy on demand.

20. A method for providing electrical power to a charging roadway for electric vehicles and operating independent of a conventional power grid, said method comprising:
providing a fuel cell for generating electricity at a location that is not connected to the conventional power grid, wherein the fuel cell can generate a variable amount of electrical power upon demand, providing a plurality of charging devices that receive the electrical power from the fuel cell, providing a charging controller that communicates with the fuel cell and determines how much electrical power should be delivered to the plurality of charging devices, and then directs the fuel cell to generate the electrical power;
providing a charging roadway that includes at least one charging lane;
disposing the plurality of charging devices in the at least one charging lane;
determining how much electricity to generate from the fuel cell to thereby provide sufficient electric energy to the plurality of charging devices; and
adjusting an electrical output of the fuel cell to provide electricity to power the plurality of charging devices in the at least one charging lane.
